(19) United States
(12) Patent Application Publication
(10) Pub. No.: US 2006/0037463 A1
(43) Pub. Date: Feb. 23, 2006

(54) Ballistic resistant plate and method for producing same

(76) Inventors: Joseph H Vittoser, Karmiel (IL); Moshe Y Shushan, Naharia (IL)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 10/542,827

(22) PCT Filed: Jan. 20, 2004
(86) PCT No.: PCT/IL04/00056

§ 371 Date: Jul. 20, 2005

(30) Foreign Application Priority Data
Jan. 22, 2003 (IL) 154083

(51) Int. Cl. F41H 5/02

(52) U.S. Cl. 89/36.02

(57) ABSTRACT

A ballistic resistant armor plate. The plate is a stack of laminae impregnated with an elastomer. Each lamina is a fabric of polyaramis impregnated with the elastomer. To prepare the armor plate, the stack of pre-impregnated laminae is cured, typically using heat and pressure. Typically, the elastomer does not react chemically with the but rather serves as a filler and binder.

### FIELD OF THE INVENTION

The present invention relates generally to devices for providing defense against bullets, shrapnel and the like. More specifically, the invention is in the field of personal protection against offensive armmunition.

### BACKGROUND OF THE INVENTION

Ballistic resistant plates (BRPs), sometimes referred to as ballistic resistant armour plates, are used for defending against the effect of bullets and fragments of artillery ammunition and mines. BRPs used for such an end are typically laminated, composed of stacked laminae and covered at one face with ceramic plates. In FIG. 1A to which reference is now made, a schematic description of bullet 20 is shown, projected in the direction of arrow 22, to eventually hit ballistic armour 24. Ballistic armour 24 is a laminated body, made of juxtaposed laminae. In FIG. 1B to which reference is now made, a schematic description of a bullet is shown, wherein bullet 20 has already hit the armour, creating a bulge 42. In the short event of bullet impingement and penetration, the plies are separated locally, this phenomenon is referred to as local delamination. Thus, as schematically shown in the figure, lamina 44 has separated from lamina 46 by gap 48, whereas lamina 46 has separated from lamina 50 by gap 52. Lamina 54 is separated from lamina 56 only to a very small extent.

Local delamination is exhibited upon the impingement on and penetration of a projectile into a laminated composite ballistic armour. In the course of a delamination, a considerable proportion of the energy of the impinging projectile hitting the armour is dissipated. This phenomenon is taken advantage of in a laminated armour, however, in order to facilitate effective local delamination, the adhesion strength must neither be too weak or rigid nor too strong. A strong adhesion tends to inhibit delamination altogether while weak adhesion would promote loosening of the bonds between the plies without withdrawing energy from the impinging projectile.

### BRIEF DESCRIPTION OF THE DRAWINGS

FIG. 1A is a schematic cross sectional view describing a projectile reaching a ballistic composite plate as in the prior art;

FIG. 1B is a schematic cross sectional view describing a projectile hitting a laminated armour plate, creating local delamination as in the prior art;

FIG. 2 is a chart describing the sequence of steps carried out in preparing a laminated armour plate in accordance with the present invention;

FIG. 3 is a schematic cross section in a prepreg of the invention;

FIG. 4 is an enlarged view of the cross section in a prepreg of the invention;

FIG. 5 is a schematic cross section in a stack of prepregs of the invention;

FIG. 6A is a schematic top side view of an armour plate describing the arrangement of ceramic tiles on a face of an armour plate of the invention;

FIG. 6B is a schematic sectional view of an armour plate of the invention describing the arrangement of ceramic tiles in the mass of the elastomer on the face of the plate.

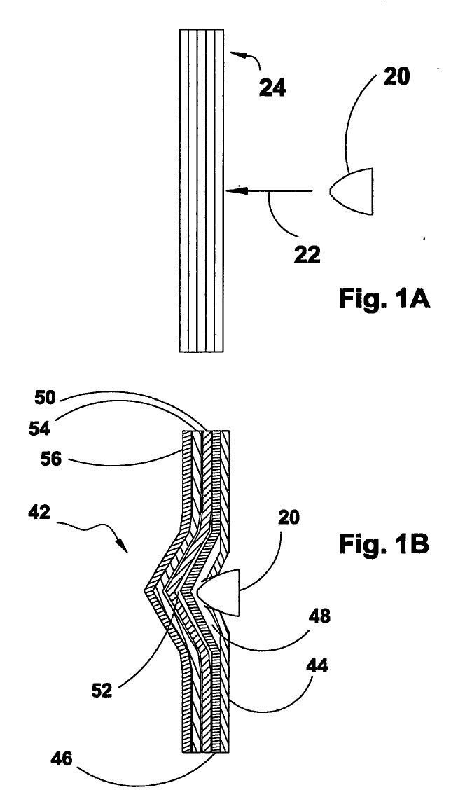

### DETAILED DESCRIPTION OF THE PRESENT INVENTION

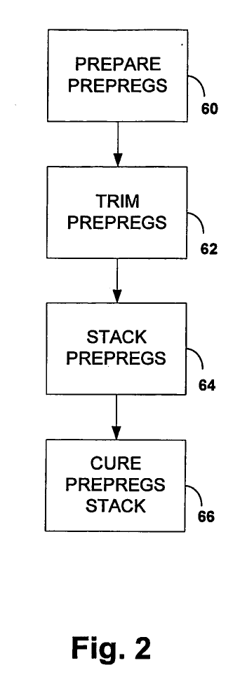

In accordance with the present invention, a stack of pre-impregnated laminae is cured using pressure and heat to form a ballistic resistant plate (BRP). The procedure for preparing the BRP of the invention is described schematically in FIG. 2 to which reference is now made. In step 60 pre-impregnated slabs, hereinafter referred to as prepregs, are prepared. In step 62 the prepregs are trimmed to fit—in a certain geometric dimension. In step 64 the prepregs are stacked and in step 66 the prepregs stack is cured using temperature and pressure.

Prepreg Preparation

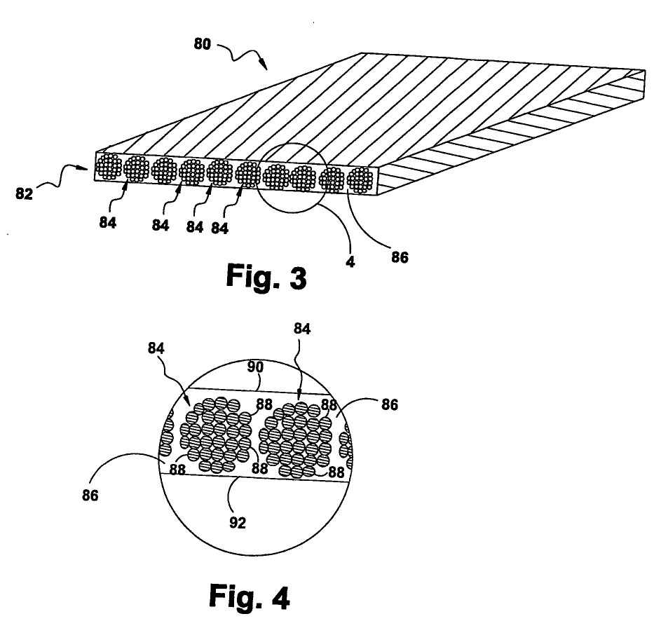

A prepreg in accordance with the present invention consists of a polyaramid fabric plate impregnated with an elastomer resin. The elastomer in accordance with the invention functions as a filler and binder, but does not necessarily interact chemically with the polyaramid fibers. The elastomer is impregnated for example by immersing the fabric in the liquefied form of the precursor of the elastomer, which is typically a dissolved or emulsified monomer. A typical solvent is xylene. The elastomer/solvent ratio effects the amount of elastomer deposited in the prepreg, and hence some of the ballistic and mechanical properties of the prepreg. By controlling the elastomer/solvent ratio a control of the delamination tendency of the armour plate can be achieved. To describe its structure, reference is made to FIG. 3, which is a schematic description of a prepreg 80 of the invention. In a front cross sectional view 82 of the prepreg, bundles 84 of the polyaramid fabric are shown, the bundles of the fabric are embedded in the semi-hardened matrix 86 of the non-cured elastomer monomer. In FIG. 4 to which reference is now made, an enlarged portion of the sectional view of the prepreg 80 is shown. Bundles 84 are composed of filaments, designated 88. Matrix 86 fills the space between the upper 90, and the lower 92 faces of the prepreg.

After impregnation, the solvent is evaporated, leaving the prepreg dried, non-sticky, and stiff enough to be easily handled.

Piling up a Stack and Curing the Elastomer

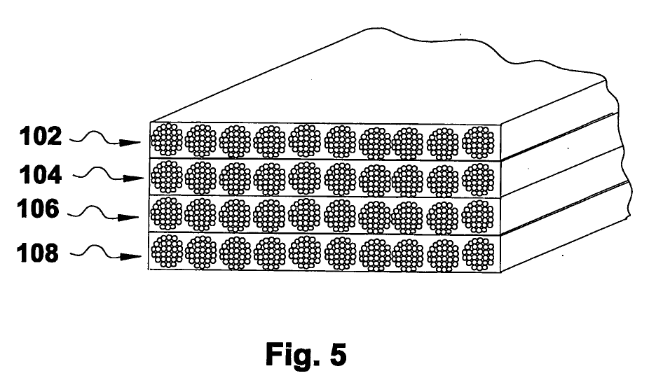

After drying, the prepregs are trimmed to a specific size which determines the vertical dimensions of the stack A stack of prepregs is described schematically in FIG. 5 to which reference is now made. Prepreg 102 is laid over prepreg 104, laid over prepreg 106, and over 108, respectively. The elastomer monomer now forms a continuum throughout the cross section of the stack.

Once the stack is formed, curing can take place, typically by applying temperature and pressure on the piled stack. The pressure can be applied by a mechanical means such as a press or isostatically by means of compressed gas in a closed chamber. Temperatures used in such curing are recommended supplied by the manufacturers of elastomer, and can also be found in various technical data publications regarding various curing techniques. Chloroprene is an exemplary elastomer precursor, known as Neoprene after curing. If rubber is used as an elastomer, vulcanization is applied as a curing method.

As a result of the curing process, (or vulcanization in the case of rubber) a laminated BRP plate is obtained, wherein a continuum of the elastomer spans the laminae between both faces of the BRP. In other words, in a cross section of the BRP, the cured elastomer forms a continuum, in which polyaramid fabric layers are embedded.

Ceramic Tile Application

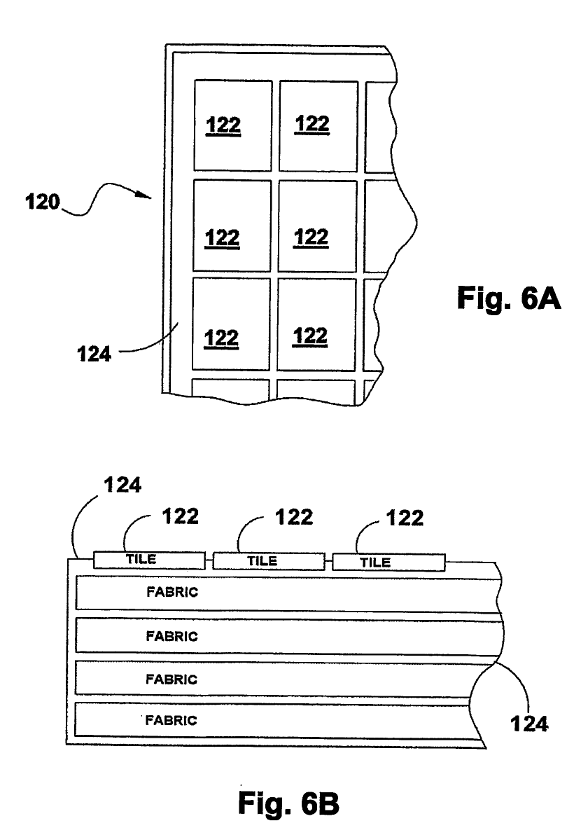

The use of elastomers in the preparation of a BRP lends itself to straightforward attachment of ceramic tiles on a face of the BRP. In a preferred embodiment of the invention, ceramic tiles are fixed to BRP using the same elastomer as the one used to prepare the BRP. In FIG. 6A to which reference is now made, a part of an armour plate 120 of the invention is shown as viewed from the top side, in which ceramic tiles 122 are embedded in the elastomer 124 of the armour. A side view of the armour of the invention is shown in FIG. 6B to which reference is now made. Tiles 122 are shown embedded in the elastomer 124 at the top side of the armour plate.

Operational Benefits of Using an Elastomer as a Binder and Filler in Accordance with the Present Invention

Experiments prove that a BRP prepared in accordance with the present invention provides for extended durability as compared to other BRPs. A BRP prepared in accordance with the present invention is able to stand more rounds of ammunition shot at from the same distance other makes of BRPs were shot at. The extended durability of a BRP of the invention means that the product of the invention is able to provide protection for a user, against more rounds of ammunition shot at.

1. A ballistic resistant armour comprising a laminated plate, wherein a stack of laminae is bound by an elastomer and wherein each lamina comprises:
a polyaramid fabric;
an elastomer impregnated in said fabric, and
wherein said elastomer forms a continuum throughout said stack of laminae.

2. A ballistic resistant armour as in claim 1 and wherein to one face of said laminated plate are attached ceramic tiles embedded in said elastomer.

3. A method for producing ballistic resistant armour using polyaramid fabric plates, comprising the steps of:
preparing prepregs by impregnating a plurality of said fabric plates with a liquefied form of an elastomer monomer;
drying said prepregs
trimming said prepregs;
forming a stack of said prepregs, and
curing said stack;

4. A method for producing ballistic resistant armour as in claim 3 and wherein said curing comprises heating and pressing said stack.

5. A method for producing ballistic resistant armour as in claim 3 and wherein vulcanization is applied in said curing step.

6. A method for controlling the delamination tendency of a laminated armour plate impregnated with an elastomer, by changing the amount of elastomer impregnated in said laminated armour plate.

7. A method for fixing ceramic tiles to a laminated ballistic armour plate, wherein said tiles are embedded in a face of a continuum of an elastomer spanning said armour plate.
